(19) United States
(12) Patent Application Publication
(10) Pub. No.: US 2023/0138816 A1
(43) Pub. Date: May 4, 2023

(54) SYSTEM AND METHOD TO REACH CONSENSUS IN A MULTI-CHAIN IOT ENVIRONMENT

(71) Applicants: Binh Minh Nguyen, Hanoi (VN); Huu-Hai-Quan Dinh, Hanoi (VN); Thang Nguyen, Hanoi (VN); Minh-Tri Hoang, Hanoi (VN); Thanh-Chung Dao, Hanoi (VN); Ba-Lam Do, Hanoi (VN)

(72) Inventors: Binh Minh Nguyen, Hanoi (VN); Huu-Hai-Quan Dinh, Hanoi (VN); Thang Nguyen, Hanoi (VN); Minh-Tri Hoang, Hanoi (VN); Thanh-Chung Dao, Hanoi (VN); Ba-Lam Do, Hanoi (VN)

(21) Appl. No.: 17/515,603

(22) Filed: Nov. 1, 2021

(51) Int. Cl. G06N 5/02; G06N 5/04; H04L 9/32; G16Y 30/10

(52) U.S. Cl. CPC G06N 5/02; G06N 5/04; H04L 9/3236; G16Y 30/10; H04L 2209/38

(57) ABSTRACT

A system configured to assist blockchain-based Internet of Things (IoT) applications connect with one another and share data securely and privately is described. The system includes an IoT network configured to interact with a blockchain network. The IoT network includes IoT systems, which include IoT devices that comprise sensors. The blockchain network includes a mainchain and sidechains. Each sidechain includes a consensus protocol that run on each node and is configured to increase data and synchronization between nodes. The consensus protocol utilizes a reasoning mechanism to enable each node to deduce states of events on other nodes, a gossip algorithm to synchronize data between nodes, and a vector clock algorithm in a knowledge graph deployed on every node to allow the event created during synchronization to be linked to the previous two events.

### FIELD OF THE EMBODIMENTS

The field of the invention and its embodiments relate to blockchain systems for Internet of Things (IoT). More specifically, the field of the invention and its embodiments relate to blockchain systems for IoT that utilize a reasoning mechanism to update a state of knowledge graph to determine which events are synchronized to at least ⅔ nodes on the network.

### BACKGROUND OF THE EMBODIMENTS

Despite the benefits that blockchain brings to traditional IoT applications, there are still many hurdles to its actual implementation. These issues, such as power consumption, scalability, and computability need to be taken into account before blockchain can be effectively applied in most IoT applications. In response to these problems, many attempts to adopt blockchain in IoT applications have been seen in recent years.

For example, sidechain technology has been used. A sidechain was firstly defined for enabling Bitcoin and other cryptocurrencies to transfer money among multiple networks at the same time. Further, sidechains should ideally be fully independent in order to share information among a mainchain and the sidechain. Sidechains may utilize their own consensus mechanisms, which can be completely different from the mainchain's consensus model.

In addition, sidechains have their own level of security, and even their own tokens. If the security of a sidechain network is compromised, the damage will not affect the mainchain or other sidechains. Sidechain networks not only improve performance, but also support the share of data between IoT systems through a main blockchain network. Specifically, sidechains connect to each other via a public mainchain by using a two-way peg component. For this reason, sidechains can ensure the required data transaction speed for IoT devices, and thus the chain can share a portion or all of their data to other blockchain IoT networks based on security levels.

Different consensus protocols can also be used for diverse sidechains to serve specific purposes. As a result, the combination of sidechains and blockchains may bring massive benefits to various IoT applications. Typical consensus protocols for blockchain-based IoT system include: the Proof of Work (PoW) consensus protocol, the Practical Byzantine Fault Tolerance (PBFT) consensus protocol, the delegated proof of stake (DPoS) consensus protocol, the Proof of Elapsed Time (PoET) consensus protocol, the Proof of Stake (PoS) consensus protocol, the Raft consensus protocol, the Tangle consensus protocol, the Hashgraph algorithm, the Proof of Authentication (PoAh) consensus protocol, and the Proof of Block and Trade (PoBT) consensus protocol, among others. However, each of these consensus protocols have drawbacks.

While the PoW consensus protocol of Ethereum™ works for Byzantine Fault Tolerance (BFT) with 51% lower than all computing resources, the throughput is quite low and the system needs a high resource consumption to create a new block. Further, the PBFT consensus protocol maintains a blockchain with low scalability and low latency.

The PoET consensus protocol of Hyperledger Sawtooth can prevent high resource utilization and energy consumption. However, to use the PoET consensus protocol, a system needs specialized hardware and requires users to put their trust in Intel chips. Similarly, though the PoS consensus protocol reduces energy consumption, the richest stakeholders can control all of the system. With the Raft consensus protocol, the system depends on the leader node and a leader leads until it fails or disconnects.

Further, with the Tangle consensus protocol, each user needs to verify two transactions in the system before sending a new transaction to the network. For that reason, the more users that use the network, the safer and faster it will become. With the Hashgraph algorithm, each node that participates in a system needs to create a new shared state and gossips it to all nodes in this system. Although the throughput of the Hashgraph algorithm is good, the large confirmation delay is caused by low communication frequency.

Though the PoAh consensus protocol reduces energy consumption, it makes the system more centralized due to trust nodes. Additionally, though the PoBT consensus protocol has been used for blockchain-based IoT in vehicular networks, allowing the validation of trades, as well as blocks with reduced computation time to increase the security for authentication, the current mainstream blockchain consensus time is still longer.

Despite the benefits of these consensus algorithms, these algorithms have significant drawbacks as discussed. Thus, what is needed is a new robust consensus protocol for sidechain networks that improves the transaction confirmation speed for blockchain-based IoT systems, and its operational mechanisms, including: use of a vector clock to determine the order of events on the blockchain network, use of a knowledge graph that stores the states of events on all blockchain nodes, use of an event reasoning mechanism for blockchain nodes to deduce the states of events on others, and an updated process for the states of events on the blockchain nodes.

### Examples of Related Art Include

U.S. Ser. No. 10/887,096B2 describes an apparatus having at least a portion of a first instance of a distributed database at a first computing device, that is configured to be included within a group of computing devices that implement, via a network operatively coupled to the group of computing devices, the distributed database. The distributed database enables anonymous transfers of digital assets between computing devices via a transfer protocol such that an identity of a computing device associated with a private key corresponding to a public key logically related to a destination record is concealed among a set of computing devices, including the first computing device and at least one second computing device.

CN112395113A describes a practical Byzantine fault-tolerant consensus method and device. The method comprises the following steps: constructing a tree topology network, where the tree topology network comprises a root node, an active sub-tree and a passive sub-tree; and completing the practical Byzantine fault tolerance consensus according to the tree topology network. According to the scheme, a traditional practical Byzantine Fault Tolerance algorithm can be effectively expanded.

WO2020237140A1 describes a method that includes numerous process steps, such as: calculating, at a first time, an identifier for a distributed database by using a first address book of the distributed database. The method also includes receiving a transaction to at least one of (1) add a computing device to the first set of computing devices, (2) remove a computing device from the first set of computing devices, or (3) modify a computing device from the first set of computing devices, to define a second set of computing devices. The method also includes defining, at a second time, a second address book. The method then includes receiving, a state proof associated with data of the distributed database after the second time. The method includes verifying the data of the distributed database by confirming that a predetermined number of computing devices from the first set of computing devices have digitally signed the second address book.

JP2020187739A describes a method for adding a new transaction node to a tangle on the basis of an IoT cryptocurrency IOTA by an electronic device.

CN111930698A describes a data security sharing method based on a hash map and federated learning. Detection of a federated learning local model is added into a hashgraph consensus algorithm of a blockchain 3.0 technology. Dishonest nodes are prevented from providing an error model. Meanwhile, the federated learning data model is realized through a method of carrying out weighted aggregation on a local model.

CN108833353B describes a quantum Byzantine agreement method based on three-party participation. Entangled resources are distributed. A broadcaster C transmits continuous variable quantum state information to receivers A and B. The receivers A and B send respectively received signal information to opposite sides and a Byzantine agreement is determined. If the Byzantine agreement fails to work, the receivers A and B determine original correlation between the receivers A and B to determine the identity of a traitor. According to the invention, entangled resources that are necessary for the Byzantine agreement solution are provided by using the continuous variable quantum graph states.

WO2020195746A1 describes a device management system, a device management method, an information processing apparatus, and a program which make it possible to improve the reliability of a device. The device management system comprises: a distributed ledger which is, for example, an IOTA tangle; a registering means that registers, in the distributed ledger, at least one of manufacture time information that is information pertaining to a process of manufacturing an IoT device, startup time information that is information pertaining to a process of starting up the IoT device, and update time information that is information pertaining to a process of updating the IoT device; and an information readout means that reads out the information registered in the distributed ledger.

CN111682942A describes a binary weighted Byzantine fault-tolerant consensus method applied to a permission blockchain. The method is provided for realizing weighted Byzantine fault tolerance consensus in O (n2) communication complexity in a weak synchronization network environment.

JP2020528231A describes an apparatus that includes a processor and a memory operatively coupled to the processor and associated with an instance of a distributed database at a first computing device. The processor is configured to select an anonymous communication path. Each blinded public key from a sequence of blinded public keys associated with the anonymous communication path is associated with a pseudonym of a computing device from a set of computing devices that implement the anonymous communication path. The processor is configured to generate an encrypted message encrypted with a first blinded public key. The processor is configured to generate an encrypted data packet including the encrypted message and a computing device identifier associated with a second computing device. The encrypted data packet is encrypted with a second blinded public key. The processor is configured to send the encrypted data packet to a third computing device.

U.S. Ser. No. 10/747,753B2 describes an apparatus that includes an instance of a distributed database at a first computing device configured to be included within a set of computing devices that implement the distributed database. The apparatus also includes a processor configured to define a first event linked to a first set of events. The processor is configured to receive, from a second computing device from the set of computing devices, a signal representing a second event (1) defined by the second computing device and (2) linked to a second set of events. The processor is configured to identify an order associated with a third set of events based at least one a result of a protocol. The processor is configured to store, in the instance of the distributed database, the order associated with the third set of events.

CN111478795A describes an alliance blockchain network consensus method based on mixed Byzantine fault tolerance, and belongs to the technical field of blockchains. The method comprises: utilizing a fragmentation mechanism to classify blockchain network nodes into four node types including common nodes, verification nodes, sorting nodes and block output nodes, where the output blocks are all nodes. Due to the characteristics of a parallel Byzantine fault-tolerant algorithm, the method also includes: dividing a consensus mechanism into two stages, including a preprocessing stage algorithm and an execution stage algorithm, and executing the preprocessing algorithm. In order to ensure the correctness of the parallel Byzantine fault-tolerant algorithm, the normal operation of the main node in a consensus mechanism is ensured by utilizing a main node view switching algorithm. Further, the parallel Byzantine fault-tolerant algorithm is executed by the output block nodes to achieve a consensus of the output block nodes, and the block output is completed by the main node in the consensus of this round. Compared with the consensus mechanism in the current alliance block chain, the security of the consensus mechanism and the consensus reaching efficiency of the node are improved.

US20200204351A1 describes a method for building agreements among nodes in a distributed system to improve the throughput of the distributed system. The method comprises performing a first Byzantine Agreement protocol; selecting a first leader node from the plurality of nodes; broadcasting a fast message from the first leader node to all other nodes when a clock is equal to 0; determining whether the first leader node decides a block according to a number of a plurality of fast-vote messages received from all other nodes by the first leader node and a value of the clock; and performing a second Byzantine Agreement protocol if it is determined that the first leader node cannot decide a block.

CN111327490A describes a Byzantine fault tolerance detection method of a blockchain and a related device. The method comprises the following steps: configuring a current test scene corresponding to each blockchain service in a blockchain service cluster; starting a target pressure test to generate a plurality of destructors and an observer; and using a plurality of destructors and an observer to execute an abnormal injection operation in a mode of combining external injection and internal injection on each blockchain service in the corresponding current test scene to obtain a Byzantine fault tolerance detection result of the blockchain. By adopting the embodiment of the invention, the detection efficiency of Byzantine fault tolerance detection of the block chain under various test scenes can be improved.

US20190251007A1 describes systems for Byzantine agreement in open networks. An indication to change a validation network for an open network from a current validation network to a next validation network may be broadcast. An agreement to change to the validation network to the next validation network may be. An instance of external validity multi-valued Byzantine agreement may be run to determine a continuing sequence number to be used by the next validation network based on the sequence numbers of amendments applied to decentralized database copies stored node computing devices of the open network. The next validation network may be switched to as the validation network for the open network after the continuing sequence number is determined. An amendment validated by the next validation network may be applied to a decentralized database copy. The amendment may include a sequence number that is higher than the continuing sequence number.

U.S. Pat. No. 6,671,821B1 describes an approach for asynchronous state-machine replication in a fault-tolerant system that offers both integrity and high availability in the presence of Byzantine faults. The approach also improves the security of previous systems by recovering replicas proactively without necessarily identifying that they have failed or been attacked. This proactive recovery limits the time extent of a particular fault by regularly recovering replicas. In this way, the system works correctly even when all the replicas fail multiple times over the lifetime of the system, provided that less than ⅓ of the replicas are all faulty within a window of vulnerability. The approach also features an efficient implementation of message authentication that prevents an attacker from impersonating a replicated node that was faulty after that node recovers.

Some similar systems exist in the art. However, their means of operation are substantially different from the present disclosure, as the other inventions fail to solve all the problems taught by the present disclosure.

### SUMMARY OF THE EMBODIMENTS

The present invention and its embodiments relate to blockchain systems for IoT. More specifically, the field of the invention and its embodiments relate to blockchain systems for IoT that utilize a reasoning mechanism to update a state of knowledge graph to determine which events are synchronized to at least ⅔ nodes on the network.

In particular, the present invention describes a system configured to assist blockchain-based Internet of Things (IoT) applications connect with one another and share data securely and privately. The system includes an IoT network and a blockchain network. The IoT network includes a plurality of IoT systems. Each IoT system of the plurality of IoT systems comprises a plurality of IoT devices that comprise sensors.

The blockchain network includes a mainchain and a plurality of sidechains. The IoT network is configured to collect data from the sensors of the plurality of IoT devices and transfer the data to the blockchain network. The plurality of sidechains receive and store the data from the plurality of IoT systems.

In examples, each sidechain of the plurality of sidechains are permissionless blockchains or permissioned blockchains. In other examples, the mainchain functions as a permissionless blockchain so that the data is public. Further, the plurality of sidechains are configured to share additional data with the mainchain via a two-way peg. The two-way peg consists of at least one node and synchronizes a block header from the plurality of sidechains to the mainchain. Additionally, the mainchain utilizes smart contracts to identify a given sidechain in the plurality of sidechains, store the block header in the sidechain corresponding to a sidechain identification, and identify an organization that can submit a new block header to a data model.

Further, each sidechain comprises a consensus protocol that runs on each node and is configured to increase data synchronization between nodes. In examples, the consensus protocol utilizes a reasoning mechanism to enable each node to deduce states of events on other nodes. Additionally, the consensus protocol utilizes a gossip algorithm to synchronize data between nodes. Moreover, the consensus protocol utilizes a vector clock algorithm in a knowledge graph deployed on every node.

The knowledge graph comprises multiple timelines, events, and synchronization arrows. The event comprises transaction data and includes a pending state or a committed state. The vector clock algorithm allows the event created during synchronization to be linked to the previous two events.

The present invention also describes a method executed by a consensus protocol running on each node in a sidechain to determine satisfying events on that node's knowledge graph. The sidechain is located in the blockchain network. The method includes numerous process steps, such as: receiving, by a node in a sidechain, a synchronization message; creating a new event on a timeline of a knowledge graph; marking the new event as a pending event; utilizing a reasoning mechanism to select a newest event on each timeline of the knowledge graph; utilizing a reasoning operator of the reasoning mechanism on each vector dimension; and modifying a satisfying event from a pending state to a committed state such that the knowledge graph is updated into a new state. The satisfying event is stored in at least two-thirds of a total number of nodes in a network.

### BRIEF DESCRIPTION OF THE DRAWINGS

FIG. 1 depicts a schematic diagram of system architecture utilized to help blockchain-based IoT applications connect with each other and share data securely and privately, according to at least some embodiments disclosed herein.

FIG. 2 depicts a schematic diagram of a data storage model of the present invention, according to at least some embodiments disclosed herein.

FIG. 3 depicts a schematic diagram of a consensus protocol of the present invention, according to at least some embodiments disclosed herein.

FIG. 4 depicts a schematic diagram of event reasoning used to determine all satisfying events on that node's knowledge graph, according to at least some embodiments disclosed herein.

FIG. 5 depicts a graphical representation of transaction latency with a 1 KB transaction, according to at least some embodiments disclosed herein.

FIG. 6 depicts a graphical representation of transaction latency with a 10 KB transaction, according to at least some embodiments disclosed herein.

FIG. 7 depicts a graphical representation of transaction latency with varying gossip intervals, according to at least some embodiments disclosed herein.

FIG. 8 depicts a graphical representation of transaction throughput of the present invention with a 1 KB transaction, according to at least some embodiments disclosed herein.

FIG. 9 depicts a graphical representation of transaction throughput of the present invention, according to at least some embodiments disclosed herein.

FIG. 10 depicts a graphical representation of event latency with varying gossip intervals of the present invention, according to at least some embodiments disclosed herein.

FIG. 11 depicts a schematic diagram of an example knowledge graph maintained by Node 1 on a network that has four nodes, according to at least some embodiments disclosed herein.

FIG. 12 depicts a schematic diagram of an example knowledge graph maintained by Node 4 on a network that has four nodes, according to at least some embodiments disclosed herein.

FIG. 13 depicts a block diagram of process steps executed by a consensus mechanism of the present invention, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by an “engine” or processor. Thus, the methods and systems of the present invention may be performed by a computer or computing device having a processor based on instructions received by computer applications and software.

The term “electronic device,” “mobile device,” or “client device,” as used herein is a type of computer comprising circuitry and configured to generally perform functions such as recording audio, photos, videos and handwritten notes; displaying or reproducing audio, photos, videos and handwritten notes; storing, retrieving, or manipulation of electronic data; providing electrical communications and network connectivity; or any other similar function. Non-limiting examples of electronic devices include: personal computers (PCs), workstations, laptops, tablet PCs, cell phones, digital music players, digital notepads, digital pens or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as smartwatches, fitness rings, fitness trackers, etc.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include WIFI and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigby network, or a voice-over-IP (VoIP) network.

As used herein, the term “database” shall generally mean a digital collection of data or information. A database may be stored on a remote server and accessed by a client device through the Internet (e.g., the database is in the cloud) or alternatively in some embodiments the database may be stored on the client device or remote computer itself (e.g., local storage). A “data store” as used herein may contain or comprise a database (e.g., information and data from a database may be recorded into a medium on a data store).

### Blockchains

As described herein, the term “blockchain” refers to a distributed database that maintains a continuously growing ledger or list of records, called “blocks,” secured from tampering and revision using hashes. Every time data is published to a blockchain database, the data may be published as a new block. Each block may include a timestamp and a link to a previous block. Through the use of a peer-to-peer network and a distributed timestamping server, a blockchain database is managed autonomously.

Permissionless blockchains are an open, distributed ledger that can record transactions between two parties efficiently and in a verifiable and permanent way. It should be appreciated that permissioned blockchains are also targeted with this present invention. Consensus ensures that the shared ledgers are exact copies, which lowers the risk of fraudulent transactions. Cryptographic hashes, such as the SHA256 computational algorithm, ensure that any alteration to transaction input results in a different hash value being computed, which indicates a potentially compromised transaction input. Digital signatures ensure that transactions originated from senders (signed with private keys) and not imposters. This covers different approaches to the processing, including hash trees and hash graphs. At its core, a blockchain system records the chronological order of transactions with all nodes agreeing to the validity of transactions using the chosen consensus model. As a result, transactions are irreversible and agreed to by all members in the network.

An example of a blockchain is a cryptocurrency. The cryptocurrency is generated when new blocks are created on the blockchain to confirm transactions of the cryptocurrency. The new blocks may confirm the transfer of cryptocurrency generated in earlier blocks. The blocks on the blockchains are cryptographically proofed and linked to earlier blocks and served as an immutable record of the events in a trustless decentralized peer-to-peer network.

For example, a cryptocurrency (e.g., Bitcoin) is represented as a chain of events that transfers ownership from one party to another party on a blockchain without an intermediary. Each event transferring ownership from one party to another is cryptographically proofed by including the public key of the new owner. Further, each event is digitally signed with the current owner's private key.

A new block in a blockchain is filled with cryptographically proofed events until the block reaches a specified size limit. A hash digest of all the event identifiers within the block and the block header of the previous block are added as the first event in the block. Each block of events may be secured by a race between participants on a peer-to-peer network. In order to win the race the participants collect new events to create the new block, validate the events on the new block by verifying the cryptographic proofs of each event to verify the cryptocurrency was not spent earlier, and solve a mathematical puzzle based on the hash digest, previous block header and a random number. Blockchain provides a mathematical hierarchy of verifiable events that is immutable and is verified at each stage by the race between the participants.

### Smart Contracts

The principles used in blockchains may be modified to allow for execution of smart contracts deployed on the blockchain. As defined herein, “smart contracts” are self-executing machine-readable instructions that store state information and are stored on the blockchain. When deployed, the smart contract is assigned a unique address to allow communication to and from the smart contract through messages. The smart contract is deployed by storing the smart contract as an event on the blockchain (e.g., Ethereum™ blockchain). Messages to the smart contract may be posted as events on the blockchain. The smart contract may contain machine-readable instructions and data designed to execute on virtual machines.

Further, the smart contract may have the ability to read or write to its internal storage storing data, read the storage of a received message, and/or send messages to other smart contracts to trigger execution of the code in other distributed applications. When the smart contract is executed on a virtual machine running on the peers securing the blockchain, the resulting data may be saved in the internal storage of the smart contract. The updated smart contract may be stored as an event on a new block. Thus, the smart contract and changes to data are represented as a series of events on the blockchain. Similar to the cryptocurrency blockchain, each block in the blockchain by mining the blockchain by peers based on a consensus protocol. It should be appreciated that not every blockchain mines blocks.

For example, in a smart contract that governs a sale of an electronic asset, the smart contract may include machine-readable instructions to access its internal storage, to read the storage of a message sent to the smart contract and to process the data in a received message, such as a counter-offer from a buyer. When the buyer sends a counter-offer to the smart contract, the smart contract may update its internal storage to include the counter-offer event, such as the identity of the buyer. The updated smart contract may be recorded as an event (e.g., a transaction) on a new block on the blockchain. As such, the blockchain stores the changes in the state of the smart contract as a series of events (e.g. a transaction).

### Internet of Things (IoT)

The Internet of Things (IoT) describes physical objects (or groups of such objects), that are embedded with sensors, processing ability, software, and other technologies, and that connect and exchange data with other devices and systems over the Internet or other communications networks. IoT is used in many sectors, such as smart home systems, supply chains, and healthcare systems. See, B. L. Risteska Stojkoska and K. V. Trivodaliev, “A review of internet of things for smart home: Challenges and solutions,” Journal of Cleaner Production, 2017, Vol. 140, P. 1454-1464; M. Abdel-Basset, G. Manogaran, and M. Mohamed, “Internet of things (IoT) and its impact on supply chain: A framework for building smart, secure and efficient systems,” Future Generation Computer Systems, 2018, Vol. 86, P. 614-628; and Z. Zhang, M. C. Y. Cho, C. Wang, C. Hsu, C. Chen, and S. Shieh, “IoT security: Ongoing challenges and research opportunities,” in 2014 IEEE 7th International Conference on Service-Oriented Computing and Applications, 2014, P. 230-234, the entire contents of which are hereby incorporated by reference in their entirety.

### Blockchain-based IoT Systems

Blockchain platforms may be applied to IoT systems to overcome security challenges. However, in an IoT environment, a large amount of data is often generated by devices, and thus the data transaction confirmation speed is one of the most important features that should be considered when deploying a blockchain network for the system. Recently, sidechains have been proposed, with the goal of increasing the number of transaction confirmations for IoT applications. Sidechains must utilize a performance consensus algorithm and the consensus algorithm also must ensure security for the sidechain networks.

Generally, in every blockchain network, the consensus protocol plays an important role to support all participants to reach an agreement about a certain problem (e.g., generating new blocks). Based on the achieved agreement, the consensus protocol handles fault tolerance issues if there are malicious participants in the network. A good consensus protocol needs to gain efficiency and consistency in order to function properly, while being efficient and cost-effective. Many consensus protocols are used by popular blockchains today, such as: PoW, PoS, DPoS, PoET, and the PBFT, among others. However, these protocols still result in limitations for blockchain systems.

### Invention

Thus, to address the aforementioned concerns, the instant invention proposes use of a vector clock in an innovative knowledge graph deployed on every blockchain node. More specifically, the system described herein has n nodes, where each event at node Nᵢ has a vector clock Cᵢ: Cᵢ=(Cᵢ[1], Cᵢ[2], Cᵢ[n]), where Cᵢ [j] is the number (or order) of events that have occurred on node j and have been synchronized to node i. Additional information regarding the vector clock may be found, at least in, R. Baldoni and M. Raynal, “Fundamentals of distributed computing: A practical tour of vector clock systems,” IEEE Distributed Systems Online, 2002, Vol. 3, No. 2, P. 12, the entire contents of which are hereby incorporated by reference in their entirety.

Based on the innovative knowledge graph, a reasoning mechanism may be used, which enables each node to deduce states of events on other nodes. Gathering event state information of other nodes helps create consensus in the blockchain network efficiently. The proposed robust protocol is named “event-link consensus” and can be deployed on sidechain networks in blockchain-based IoT environment.

The protocol of the present invention increases the number of transaction confirmations of sidechain in comparison with current consensus algorithms. In addition, the proposed protocol also prevents PBFT issues, and therefore ensures the security for the sidechain networks. Furthermore, based on the significance of the consensus algorithm chosen, the instant invention provides a new robust consensus protocol for sidechain networks that improves the transaction confirmation speed for blockchain-based IoT systems, and its operational mechanisms, including: use of a vector clock to determine the order the events on the blockchain network, use of a knowledge graph that stores event states on all blockchain nodes, use of an event reasoning mechanism for blockchain nodes to deduce the event states on others, and an updated process for the event states on the blockchain nodes.

### Architecture

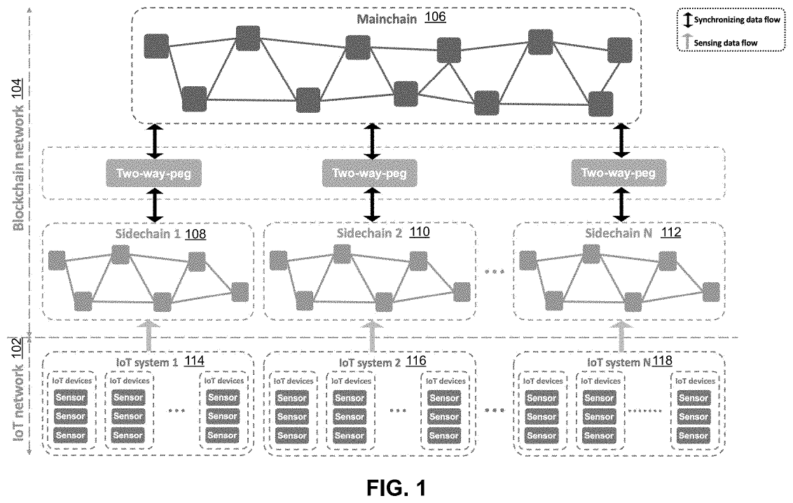

The instant invention provides an architecture to help blockchain-based IoT applications connect with each other and share data securely and privately. The architecture may be depicted in FIG. 1. The architecture of FIG. 1 allows applications to act as sidechains (e.g., a first sidechain 108, a second sidechain 110, and another sidechain 112) operating independently of a mainchain 106. The sidechains (e.g., the first sidechain 108, the second sidechain 110, and the other sidechain 112) share data via the mainchain 106. Furthermore, it should be appreciated that the architecture of FIG. 1 is an open architecture that allows the sidechains (e.g., the first sidechain 108, the second sidechain 110, and the other sidechain 112) using different blockchain platforms to join the network and interconnect with each other.

More specifically, the architecture of FIG. 1 includes two networks: an IoT network 102 and a blockchain network 104. The IoT network 102 includes numerous systems, such as a first IoT system 114, a second IoT system 116, and another IoT system 118. A quantity of the IoT systems is not limited to any particular quantity. Each of the IoT systems includes IoT devices that include sensors. A quantity of the IoT devices and/or the sensors is not limited to any particular quantity. For example, the IoT systems may include smart home systems, factory systems, traffic control systems, etc. The IoT network 102 collects data from the sensors of the IoT devices to transfer to the blockchain network 104.

The blockchain network 104 includes the first sidechain 108, the second sidechain 110, the other sidechain 112, and the mainchain 106. It should be appreciated that a quantity of the sidechains is not limited to any particular quantity. In the blockchain network 104, the nodes in the sidechains (e.g., the first sidechain 108, the second sidechain 110, and the other sidechain 112) directly receive and store data from the IoT systems (e.g., the first IoT system 114, the second IoT system 116, and the other IoT system 118). Each sidechain network will only receive data from a single IoT system and vice versa because this is considered as a blockchain-based IoT system.

In addition, in FIG. 1, the relationship between the mainchain 106 and the sidechains (e.g., the first sidechain 108, the second sidechain 110, and the other sidechain 112) is shown. The sidechains (e.g., the first sidechain 108, the second sidechain 110, and the other sidechain 112) can share their data with the mainchain 106. To do that, a two-way peg is used, which acts as a bridge between a given sidechain and the mainchain 106. The two-way peg will process the normalization of the data when sent from the given sidechain. In addition, the two-way peg will also help to get data from the mainchain 106 and send it back to the given sidechain.

Further, the sidechains (e.g., the first sidechain 108, the second sidechain 110, and the other sidechain 112) can use permissionless or permissioned blockchains at will. In some examples, the mainchain 106 may function like a permissionless blockchain, so that the data will be public and so other sidechains can receive data from the mainchain 106. As such, the architecture of FIG. 1 allows blockchain-based IoT applications to connect with each other and share data through the mainchain 106.

### Data Storage Model

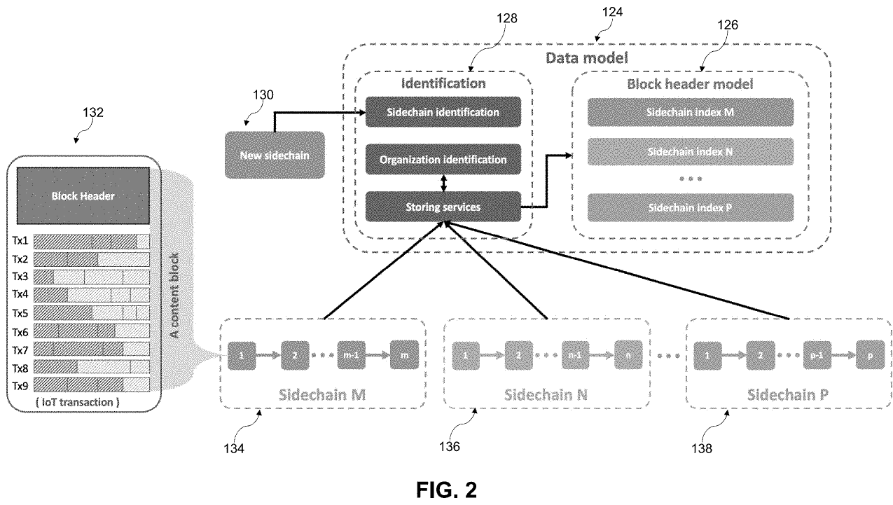

Architecture of a data storage model 124 of the present invention is depicted in FIG. 2. The architecture of the data storage model 124 of the present invention generally includes the following components of FIG. 1: the sidechains (e.g., the first sidechain 108, the second sidechain 110, and the other sidechain 112), the mainchain 106, and the two-way peg protocol. More specifically, the data storage model 124 includes sidechain identification 128 and a block header model 126.

As discussed, the sidechains (e.g., the first sidechain 108, the second sidechain 110, and the other sidechain 112 of FIG. 1) are usually permissioned blockchain that are maintained by one or more organizations. The sidechains (e.g., the first sidechain 108, the second sidechain 110, and the other sidechain 112 of FIG. 1) have their own consensus protocol and token, with the amount of data being generated continuously and quickly from multiple IoT devices. The sidechains (e.g., the first sidechain 108, the second sidechain 110, and the other sidechain 112 of FIG. 1) are responsible for ensuring that the storage is fast, accurate and complete. Due to the low decentralization, the sidechains (e.g., the first sidechain 108, the second sidechain 110, and the other sidechain 112 of FIG. 1) become less transparent and immutable.

As described with relation to FIG. 1, the two-way peg can consist of a node or a group of nodes and is responsible for synchronizing a block header 132 of FIG. 2 from the sidechains (e.g., the first sidechain 108, the second sidechain 110, or the other sidechain 112 of FIG. 1) to the mainchain 106 of FIG. 1. The goal of this process is to leverage the security and decentralization of public blockchain networks to ensure immutability of sidechains and make it more transparent. The process of synchronizing data must be exact and complete to ensure immutability of the sidechain (e.g., the first sidechain 108, the second sidechain 110, or the other sidechain 112 of FIG. 1) on the mainchain 106.

In the present system, and as shown in FIG. 1 and FIG. 2, the mainchain 106 is designed using smart contracts that ensure the following functions: (1) identification of the sidechain (e.g., a sidechain M 134, a sidechain N 136 or a sidechain P 138 of FIG. 2) and (2) an identification of an organization who can submit a new block header 132 to the data model 124. It should be appreciated that the organization can join multiple sidechains and have permission to submit the new block header for those sidechains. Further, the sidechain identification 128 may identify new sidechains 130.

In general, the data storage process in the present system includes the following process steps: posting IoT data to the sidechain inside transactions, encapsulating transactions inside blocks (events) to ensure immutability within the sidechains, synchronizing the newly created block header 132 in the sidechain to the smart contract on the mainchain 106, and updating the block header 132 in transactions of valid blocks on the mainchain network. Therefore, the system described herein can improve security and decentralization by adopting architecture that uses the public blockchain network.

### Consensus Mechanism and Knowledge Graphs

The present invention also describes a consensus mechanism aimed at increasing data and synchronization between nodes participating in the network. The following terminology will be used to describe the consensus mechanism of the instant invention.

As described herein, each node on the network maintains an “event knowledge” or “EK” that can be considered as a distributed ledger of the network. Each node will store a set of linked events. At the same time, the EK on a node can be diverse from another, but they tend to be similar during the network's operation process. When the synchronization is complete with another node, the synchronous node will be updated with the EK and its data.

When a new event is created based on two events (e.g., the previous event of the node that created the event and the latest event of the node sending the synchronized message), the “event pending” or “EP” is formed. In other words, the new event will be pushed into a pending approval state. The state “pending” means that the event still hasn't been broadcasted (e.g., by a Gossip protocol) to at least ⅔ of the total number of nodes in the network.

The state “event committed,” “committed,” or “EC” means that the event has been broadcasted successfully to at least ⅔ of the total number of nodes in the network.

The terms “event reasoning” or “ER” is used to determine all satisfying events on that node's knowledge graph. The satisfying event is one that have been stored in at least ⅔ of the total number of nodes on the network. When a node receives a synchronized message, it will create a new event on its corresponding timeline of the knowledge graph. Once an event is created, it will be set as a pending event. Synchronized nodes run the ER to determine the satisfying events, which are synchronized into at least ⅔ of the total number of nodes on the network. After that, in the final step of the consensus mechanism, all satisfying events will be changed into EC, meaning that the EK is updated into a new state.

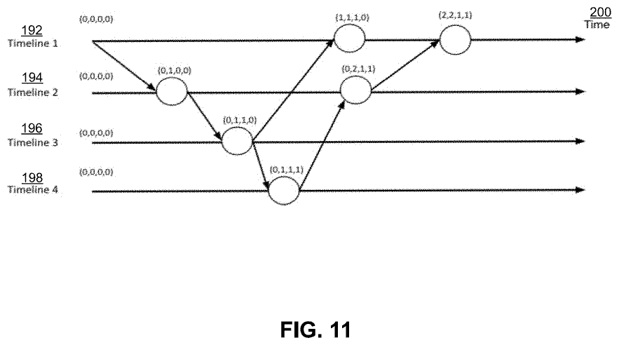

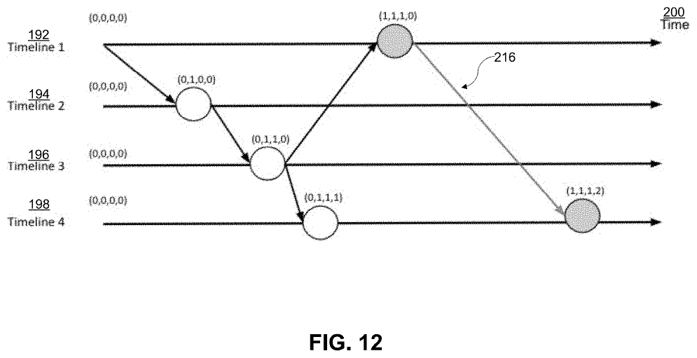

Example knowledge graphs are depicted in FIG. 11 and FIG. 12. Specifically, an example of a knowledge graph used with the present invention that is maintained by Node 1 on a network that has four nodes is depicted in FIG. 11. Specifically, FIG. 11 depicts a first timeline 192, a second timeline 194, a third timeline 196, a fourth timeline 198, and a time 200. FIG. 12 depicts an example of another knowledge graph that is maintained by Node 4 on the network that has four nodes. Specifically, FIG. 12 depicts the first timeline 192, the second timeline 194, the third timeline 196, the fourth timeline 198, and the time 200. Further, FIG. 11 and FIG. 12 show the knowledge graphs maintained on Node 1 and Node 4 at the same time.

The following are the main components of the knowledge graphs: a timeline, an event, and a synchronization arrow. More specifically, each knowledge graph has n timelines corresponding with n number of nodes in the network. Each timeline (e.g., the first timeline 192, the second timeline 194, the third timeline 196, and the fourth timeline 198) shows events on its corresponding node that are synchronized into the current node. As an example, the knowledge graph in FIG. 12 is maintained by Node 4 on the four peer nodes network. The timeline one 192 in FIG. 12 shows events on Node 1 synchronized into Node 4 (e.g., the current node, which stores the knowledge graph).

With regards to FIG. 11 and FIG. 12, each event contains transaction data. The event is denoted by its own vector clock. More specifically, the event has two states: a pending state and a committed state. The synchronization arrow or synchronized message 216 shown in FIG. 12 indicates that a node sent the synchronized message to another. In FIG. 12, the knowledge graph is maintained by Node 4 and the synchronization arrow 216 from the event with vector clock (1, 1, 1, 0) on the timeline one 192 to the event with vector clock (1, 1, 1, 2) on the timeline four 198 indicates that Node 1 sent a synchronized message to Node 4. After receiving the synchronized message, Node 4 creates a new event, as shown in Table 1 below:

TABLE 1

| | |
|---|---|
| The vector clock of Node 1 and the | Node 1 (1, 1, 1, 0) |
| vector clock of Node 4 are: | Max Node 4 (0, 1, 1, 1) |
| MAX-operation to obtain a max | Max vector clock (1, 1, 1, 1) |
| vector clock | |
| Count the max vector clock at the | Max vector clock (1, 1, 1, 1) |
| dimension corresponding to Node 4 | +1 |
| (i.e., the fourth dimension): | update Node 4 (1, 1, 1, 2) |

The new event created by Node 4 has the vector clock: (1, 1, 1, 2).

In general, each current IoT application has its own blockchain network with a different consensus protocol, which causes problems for parties to share data because of different platforms. For example, IoT application A using platform one will have difficulty sharing data with IoT application B with platform two.

With the consensus mechanism described herein, instead of using “block” for data, an “event” is used. For normal block generation, the node creates a new block that contains the hash of a block immediately before it. Then, the new block is sent to the participants in the system for validation and confirmation to be added to the blockchain. Unlike block generation, an event is fired when one node receives a synchronization message from another node in the system. At a specified time, a node sends its latest event to any node. During this synchronization, a new event is created on the synchronous node. After each synchronization process, nodes in the system will store a set of events linked together that have corresponding vector clocks called “Event Knowledge”. The structure of an event builds on a previous vector clocks and adds other enhancements that speed up a consensus between nodes.

As described, the consensus mechanism described herein takes advantage of the vector clock algorithm. Vector clock algorithms are used in distributed systems to determine whether pairs of events are causally correlated. Using vector clock algorithms, timestamps are created for each event in the system, and their fundamental relationship is determined by comparing those timestamps.

In addition, a gossip algorithm is also utilized with this system described herein to synchronize data between nodes. However, in a network where there may be dishonest nodes, fault tolerance helps the network both increase security and quickly reach consensus between nodes early.

Based on the idea of the vector clock algorithm, an event created during synchronization is always linked to the previous two events. As such, the following events are always linked to previous events and support a sync button that traces the event. Besides, the application of the vector clock algorithm helps the node get information about the number of synchronizations of the nodes in the network. When receiving events from another node synchronizing to, the receiving node will rely on the data it has to confirm which state a certain event is in (e.g., accepted, canceled, or processed). As a result, the acceptance rate of an event will be faster. Based on the vector clock algorithm, that node can automatically accept an event in its processing state.

It should be appreciated that the consensus mechanism of the present invention functions as follows:
Step 1: Initially for a system with n nodes, each event at node Nᵢ (0≤i<n) has a vector clock Cᵢ^{k} (0≤i<n, 0≤k), which can be formulated as in Equation 1:

Cᵢ^{k}=(Cᵢ^{k}[1],Cᵢ^{k}[2], . . . Cᵢ^{k}[n]) Equation 1

where n is the number of nodes that are participating in a network and Cᵢ^{k} is the k event that has occurred on the i^{th} node. As such, the elements in the vector clock are arranged in the order of position in the blockchain and the value of the elements corresponds to the number of synchronizations of that node. So, at the initialization step, all element values in the vector clock are equal to 0.
Step 2: After the node has been initiated with a list of nodes in the network, it will start sending a synchronized message to a random node including the transactions. In this stage, the node of execution also sends all transactions that were done at that node in the past. Different nodes in the network will gradually collect all of the information of the remaining nodes, aiming at the Event Knowledge of each node tending to be similar during the network's operation process. An Event Knowledge of a node contains information of the other nodes at the last time it was synchronized Kᵢ (0≤i<n, 0≤k) which can be formulated as in Equation 2:

Kᵢ=Kᵢ⁰,Kᵢ¹, . . . Kᵢⁿ) Equation 2

where n is the number of nodes that are participating in a network and Kᵢ^{j} is knowledge of node i about node j, with

Kᵢ^{j}=(Cⱼ⁰,Cⱼ¹, . . . Cⱼ^{k}) Equation 3

where Cⱼ^{k} is a vector clock of event k^{th} in node j and k is the number of events on node j that synchronized to the node i.
Step 3: A random node that received a synchronization message starts checking the synchronization data. Valid data is saved to the node's database. This node continuously will create a new event. The event will include two events and new transactions on this node. Finally, the new event will be set as an Event Pending.
Step 4: After an event is created, the event reasoning mechanism is triggered. The synchronized node runs the event reasoning mechanism to check for Event Pending in its EK. The event pending, when it has been synchronized at least ⅔ of the total number of nodes on the network, is converted from the “pending” state to the “committed” state.

From Step 2 described above, the steps are repeatedly performed to maintain the blockchain network. The synchronized node will automatically send the synchronization message to a random node or will receive it from another node to run the consensus mechanism. Other nodes in the network will do the same thing to reach a consensus quickly. If a new node wants to join the network, it needs to start from Step 1 described above.

The specific algorithms utilized with the consensus mechanism described are represented below:

Algorithm 1 Create new Event

| | Input: |
|---|---|
| | Eᵢⁿ - Event n of node i that receives message |
| | Eⱼ^{m} - Event m of node j that sends message |
| | Output: new Event Eᵢ^{n + 1} |
| 1: | while true do |
| 2: | CHECK event of node that sends synchronized mes- |
| | sage |
| 3: | if true then |
| 4: | UPDATE Event Knowledge about Kⱼ^{m} to Kᵢ |
| 5: | end if |
| 6: | length ← length of Cᵢ^{k} |
| 7: | for 0 ≤ a < length do |
| 8: | if Cᵢⁿ[a] ≤ Cⱼ^{m}[a] |
| 9: | Cᵢⁿ⁺¹[a] ← Cⱼ^{m}[a] |
| 10: | else |
| 11: | Cᵢⁿ⁺¹[a] ← Cᵢ^{m}[a] |
| 12: | end if |
| 13: | end for |
| 14: | Cᵢⁿ⁺¹[i] ←Cᵢ^{m+1}[a] + 1 - add 1 to clock of the newest |
| | event of node i |
| 15: | Push new Event Eₛⁿ⁺¹ to Event Pending State |
| 16: | UPDATE Event Knowledge about Kᵢⁿ⁺¹ to Kᵢ |
| 17: | end while |

Algorithm 2 Event reasoning mechanism

| | Inputs |
|---|---|
| | Kᵢ - Event Knowledge of node i |
| | Cᵢ^{k} - the vector clock of newest event on node i |
| | Output: |
| | Update state of Event on Kᵢ |
| 1: | while true do |
| 2: | for a = 0 to length of Cᵢ^{k} do |
| 3: | clockvalue ← Cᵢ^{k}[a] - get value clock in Cᵢ^{k} |
| 4: | get vector dock from node a Cₐ^{clockvalue} |
| 5: | end for |
| 6: | check all events that had at least on 2/3 of all nodes |
| 7: | if true then |
| 8: | Update state of Event to EventCommitted |
| 9: | end if |
| 10: | end while |

Algorithm 3 Event-link consensus

| | |
|---|---|
| 1: | Initial N node with all the clocks are set to 0. |
| 2: | while true do |
| 3: | Upon sending |
| 4: | Send synchronized message to a random node |
| 5: | End upon sending |
| 6: | |
| 7: | Upon receiving |
| 8: | If Receive synchronized message then |
| 9: | CHECK event of node that sends synchronized |
| | message |
| 10: | if CHECK is true then |
| 11: | UPDATE Event Knowledge |
| 12: | CREAT new Event (Algorithm 1) |
| 13: | If CREAT success then |
| 14: | Activale Event Reasoning mechanism (Algo- |
| | rithm 2) |
| 15: | UPDATE Event Knowledge |
| 16: | end if |
| 17: | end if |
| 18: | end if |
| 19: | End upon receiving |
| 20: | end while |

Note: N is number of nodes, nᵢ is i^{th} node

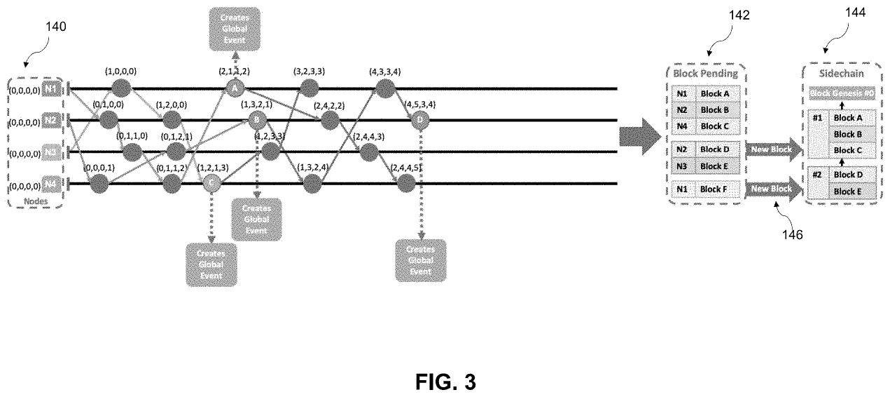

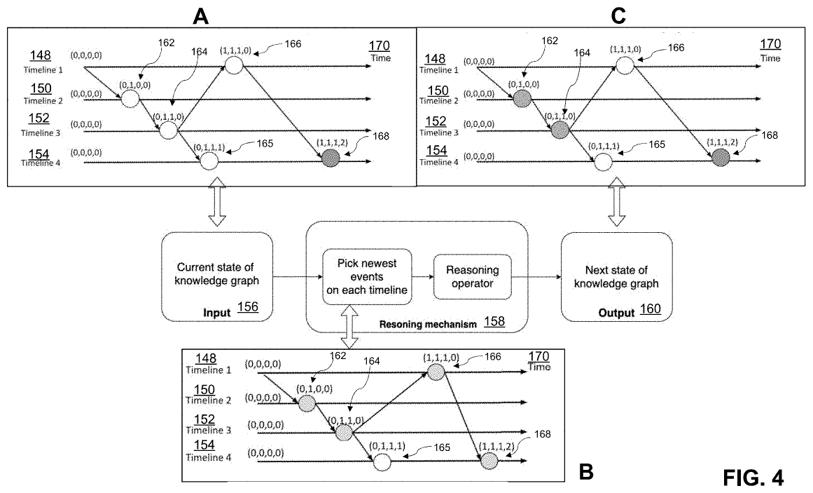

Moreover, the consensus protocol of the present invention is depicted generally in FIG. 3 and includes nodes 140 (e.g., N1-N4), pending blocks 142, a sidechain 144, and new blocks 146. Specifically, the ER is depicted in FIG. 4. FIG. 4 includes three graphs: A, B, and C. Each graph in FIG. 4 includes a first timeline 148, a second timeline 150, a third timeline 152, a fourth timeline 154, and a time 170.

Specifically, Graph A of FIG. 4 shows Node 4 receiving a synchronized message. Further, nodes 162, 164, 165, and 166 in Graph A are associated with pending events and node 168 is associated with a new event. Further, in Graph B, nodes 162, 164, 166, and 168 are all associated with the newest event on each timeline. Nodes 162 and 164 of Graph C are associated with committed events, nodes 165 and 166 are associated with a pending event and node 168 is associated with a new event.

More specifically, the method steps associated with the consensus protocol of FIG. 4 include: (1) selecting the newest events on each timeline on the knowledge graph. The newest event satisfies the following requirements simultaneously: creates the corresponding node of that timeline and synchronizes on the current node. As an example, Graph B of FIG. 4 shows the newest events (e.g., the nodes 162, 164, 166, and 168) on each timeline of the knowledge graph (stored on Node 4) after Node 4 creates a new event with a vector clock (1, 1, 1, 2). Concretely, with regards to Graph B of FIG. 4, the event with vector clock K1 (1, 1, 1, 0) is the newest event on timeline one 148, the event with vector clock K2 (0, 1, 0, 0) is the newest event on timeline two 150, the event with vector clock K3 (0, 1, 1, 0) is the newest event on timeline three 152, and the event with vector clock K4 (1, 1, 1, 2) is the newest event on timeline four 154.

Further, the reasoning mechanism 158 is used on each dimension of (K1, K2, K3, K4) to determine satisfying events. The reasoning mechanism 158 is defined such that it includes three components: (1) an input 156, (2) a checking step, and (3) an output 160.

Regarding the input 156 in FIG. 4, vector v₁ describes the newest event created by a node i that is synchronized to all nodes on the network and all those synchronization processes are synchronized on the current node. As an example, in Graph C of FIG. 4 on the knowledge graph of Node 4, there are two events (0, 0, 0, 0) and (1, 1, 1, 0) corresponding to the first and the second event that are created by Node 1 and were synchronized on Node 4.

More specifically, Vector v₁=(1, 0, 0, 1) describes the following: (1) the value of the first dimension of Vector v₁ is 1 (e.g., the second event with vector clock (1, 1, 1, 0) is the newest event that is created by Node 1 and this event was synchronized on Node 4), (2) the value of the second dimension of Vector v₁ is 0 (e.g., the first event with vector clock (0, 0, 0, 0) is the newest event that is created by Node 1 and this event was synchronized on Node 2 and this synchronization process is synchronized on Node 4), (3) the value of the third dimension of Vector v₁ is 0 (e.g., the first event with vector clock (0, 0, 0, 0) is the newest event that is created by Node 1 and this event was synchronized on Node 3 and this synchronization process is synchronized on Node 4); and (4) the value of the fourth dimension of Vector v₁ is 1 (e.g., the second event with vector clock (1, 1, 1, 0) is the newest event that is created by Node 1 and this event was synchronized on Node 4).

Regarding the checking step executed by the reasoning mechanism 158 in FIG. 4, the set S in which its elements are less than or equal to the values of at least ⅔ elements of the vector v₁ (x₁, x₂, x₃, x₄) are checked. As an example, Vector v₁=(1, 0, 0, 1)=>S={0}, where:
the initial of S={ }
x₁=1≤x₁, x₄=>S={ } because x₁ is not less than or equal the value of at least ⅔ elements of v₁;
x₂=0≤x₁, x₂, x₃, x₄=>S={0} because x₂ is less than or equal the value of at least ⅔ elements of v₁;
x₃=0≤x₁, x₂, x₃, x₄=>S={0, 0} because x₃ is less than or equal the value of at least ⅔ elements of v₁; and
x₄=1≤x₁, x₄=>S={0, 0} because x₄ is not less than or equal the value of at least ⅔ elements of v₁.
   As another example, Vector v₁(3, 1, 2, 6)=>S={1, 2}, where:
the initial of S={ }
x₁=3≤x₁, x₄=>S={ } because x₁ is not less than or equal the value of at least ⅔ elements of v₁;
x₂=1≤x₁, x₂, x₃, x₄=>S={1} because x₂ is less than or equal the value of at least ⅔ elements of v₁;
X₃=2≤x₁, X₃, X₄=>S={1, 2} because x₃ is less than or equal the value of at least ⅔ elements of v₁; and
X₄=6≤X₄=>S={1, 2} because x₄ is not less than or equal the value of at least ⅔ elements of v₁.
   The maximum value of set S (maxS) is the largest event created by a node i, which is synchronized to at least ⅔ of the nodes on the network that are synchronized to the current node.

Regarding the output step 160 of FIG. 4, all of the events on the timeline i from 0-th to maxS are the satisfying events. As an example, the newest events on each timeline are as follows: Vector clock K1: (1, 1, 1, 0); Vector clock K2: (0, 1, 0, 0); Vector clock K3: (0, 1, 1, 0); and Vector clock K4: (1, 1, 1, 2).

On each vector clock, the dimensions of the largest event are run. For dimension 1, vector v₁=(1, 0, 0, 1), which corresponds to the first dimension of all (K1, K2, K3, K4); and S={0} =>maxS=0, where no events on timeline one 148 are satisfying events. For dimension 2, vector v₂=(1, 1, 1, 1), which corresponds to the second dimension of all (K1, K2, K3, K4); and S={1}=>maxS=1=>event (0, 1, 0, 0) on timeline two 150 is the satisfying event. For dimension 3, vector v₃=(1, 0, 1, 1), which corresponds to the third dimension of all (K1, K2, K3, K4); and S={1}=>maxS=1=>Event (0, 1, 1, 0) on timeline three 152 is satisfying event. For dimension 4, vector v₄=(0, 0, 0, 2), which is the fourth dimension of all (K1, K2, K3, K4); and S={0}=>maxS=0, where no events on timeline four 154 are satisfying events.

In the other words, the operational flow of the consensus mechanism using the reasoning mechanism 158 on FIG. 4 also can be described as follows: (1) Node 4 creates an event (1, 1, 1, 2) after receiving a synchronized message; (2) Node 4 picks the newest events on each timeline of its own knowledge graph; (3) Node 4 runs a reasoning operator to determine that the event (0, 1, 0, 0) on timeline two 150 and event (0, 1, 1, 0) on timeline three 152 are satisfying events (e.g., the events that are synchronized on at least ⅔ nodes on the network); and (4) Node 4 changes the state of event (0, 1, 0, 0) on timeline two 150 and the event (0, 1, 1, 0) on timeline three 152 into the committed state. Then, the new state of the knowledge graph is updated.

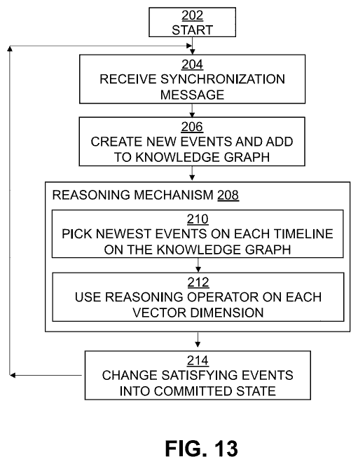

FIG. 13 also depicts a block diagram of the process steps of the consensus mechanism running on each node. The consensus mechanism utilizes the reasoning mechanism 208 of FIG. 13 (or the reasoning mechanism 158 on FIG. 4) to determine all satisfying events on that node's knowledge graph. As described, the satisfying event is one that have been stored in at least ⅔ of the total number of nodes on the network.

Specifically, the method of FIG. 13 begins with a process step 202, which is followed by a process step 204, where a node receives a synchronized message. A process step 206 follows the process step 204, which includes creation of a new event on its corresponding timeline of the knowledge graph. Specifically, once an event is created at the process step 206, it will be set as a “pending” event.

Then, a process step 210 follows the process step 206 and includes the reasoning mechanism 208 picking the newest events on each timeline of the knowledge graph. A process step 212 follows the process step 210 and includes the reasoning mechanism 208 using a reasoning operator on each vector dimension. The goal of the process step 210 and the process step 212 is to evaluate the current graph and determine which event is synchronized at least ⅔ on the network. A process step 214 follows the process step 212 and includes changing the satisfying events into a committed state, meaning that the knowledge graph is updated into a new state. Further, it should be appreciated that the goal of the process step 214 is to create the new state of the knowledge graph by committing all satisfying events. The process step 214 concludes the method of FIG. 13.

### EXAMPLES

Several experiments were conducted using the consensus mechanism proposed herein. Python language programing was used to launch and benchmark the consensus mechanism. Docker was used so that each node was built and ran in a container independently. Nodes synchronize data with each other through RabbitMQ, which is an open-source message-broker software.

In addition, other consensus mechanisms were used, such as PBFT, PoW, PoET, and Raft, for comparison purposes. These consensus mechanisms were deployed on different platforms. PBFT and PoET are deployed on the Hyperledger Sawtooth Blockchain platform, the PoW consensus mechanism was deployed on the Ethereum™ Blockchain platform, and the Raft consensus was evaluated on Hyperledger Fabric platform.

The proposed consensus algorithm was evaluated on three criteria: (1) transaction latency, (2) transaction throughput, and (3) average block closing time. Due to hardware limitations, the consensus mechanism of the instant invention was tested with five scenarios: 4, 7, 10, 13 and 16 nodes based on fault tolerance (3f+1) with f=1, 2, 3, 4, 5. With PBFT and PoET, 4, 7, 10 validators were built running on the Hyperledger Sawtooth platform. Similarly, Pow was evaluated on the Ethereum™ blockchain platform with 4, 7 and 10 nodes, respectively. Additionally, 4, 7, and 10 orderer nodes in Hyperledger Fabric were built to measure the performance of the Raft consensus mechanism. Further, the Hyperledger Caliper tool was used to measure Transactions Per Second (TPS) and transaction latency of the Raft and PoET consensus mechanisms.

### Transaction Latency

As discussed, the performance of the instant consensus mechanism was evaluated based on a transaction latency parameter. Specifically, as described herein, “transaction latency” can be measured by the time from when the transaction is sent to the blockchain network until it is recorded in the ledger. The transaction creation time is not taken into account.

The test was configured with 4, 7, 10, 13, and 16 nodes for five consensus mechanism: PBFT, PoET, PoW, Raft, and the consensus mechanism of the present invention. The transaction size used in networks is 1 KB and 10 KB, respectively. In addition, the default gossip time of the event-link consensus was set to be 1 second.

### Example 1: Transaction Latency with a 1 KB Transaction

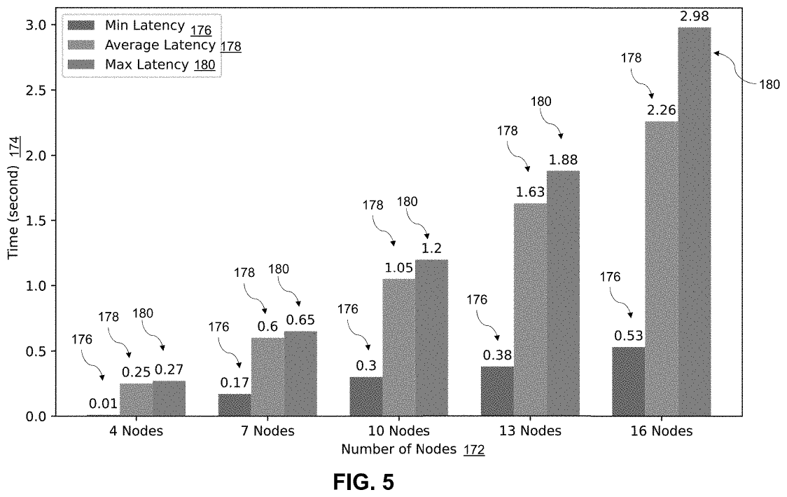

Specifically, in the case of a 1 KB transaction size, the maximum latency, minimum latency and average latency was measured in 5 cases (e.g., 4, 7, 10, 13 and 16 nodes) as shown in FIG. 5. Specifically, FIG. 5 includes a graph having an x-axis 172 associated with a number of nodes and a y-axis 174 associated with a time in seconds. A minimum latency 176, an average latency 178, and a maximum latency 180 are depicted in FIG. 5 based on the number of nodes and the time.

In each case, 5000 transactions were sent to the network. All cases had a default gossip interval of 1 second. When there were 4 endorsing peers in the network, the transaction latency was notably small. The maximum latency 176 was 0.27 seconds, the average latency 178 was 0.25 seconds, and the minimum latency 180 was 0.01 seconds. As the number of nodes on the network increased, so did the latency of the transaction. When the number of nodes increased to 7, the maximum latency 176 was 0.65 seconds, the average latency 178 was 0.6 seconds, and the minimum latency 180 was 0.17 seconds. When the number of nodes went up to 10, 13 and 16, the average latency 178 went up to 1.05, 1.63 and 2.26 seconds, respectively.

In general, as shown in FIG. 5, each time the number of nodes increases by 3 based on fault tolerance (3f+1), the transaction latency increased. The graph of average trading latency forms a straight line that tends to go up linearly.

### Example 2: Transaction Latency with a 10 KB Transaction

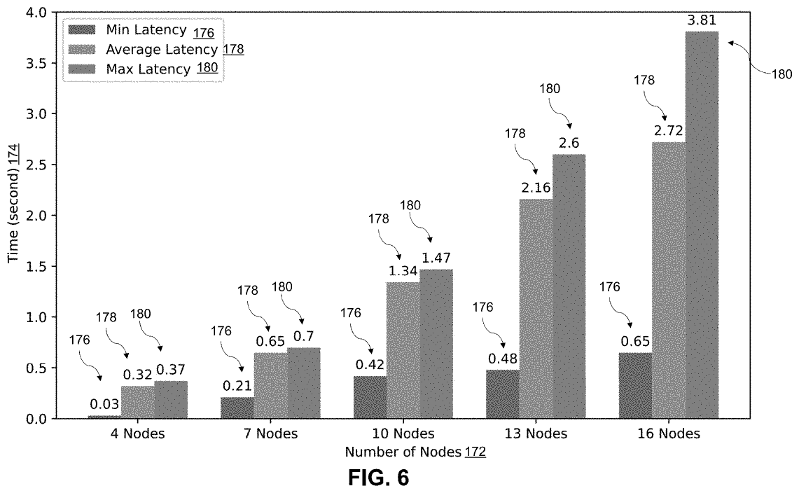

This problem from FIG. 5 was extended by measuring the performance of the consensus mechanism of the present invention when the size of the transaction was 10 KB, and for each test case, 5,000 transactions were sent to the network. Specifically, FIG. 6 includes a graph having an x-axis 172 associated with a number of nodes and a y-axis 174 associated with a time in seconds. A minimum latency 176, an average latency 178, and a maximum latency 180 are depicted in FIG. 6 based on the number of nodes and the time.

In FIG. 6, the experimental results for 5 scenarios (e.g., 4, 7, 10, 13 and 16 nodes) all achieved an increasing trend of transaction latency, but the delay gap dropped over time. Although the transaction size increased by 10 times, the latency trend of FIG. 6 is relatively the same with that of FIG. 5.

### Example 3: Comparison Between the Average Transaction Latency of the Proposed Consensus Mechanism with Other Reference Consensus Mechanisms

Table 2 below depicts results that compare the average transaction latency of the proposed consensus mechanism with other reference consensus mechanisms. Transactions used in this experiment have two sizes of 1 KB and 10 KB respectively. Due to the hardware limitations, four consensus algorithms (PBFT, PoET, PoW, Raft) cannot run with more than 10 nodes, so they are only evaluated with 4, 7 and 10 nodes. However, the consensus mechanism of the present invention can take advantage of the machine's hardware to run smoothly with 13 and 16 nodes, as shown in FIG. 5 and FIG. 6.

TABLE 2

| Transaction | Consensus | Number of nodes | | | | | |
|---|---|---|---|---|---|---|---|
| size | protocol | 4 Nodes | | 7 Nodes | | 10 Nodes | |
| 1 KB | PBFT | 0.72 | s | 0.93 | s | 1.06 | s |
| | PoET | 0.02 | s | 0.03 | s | 0.04 | s |
| | PoW | 28 | s | 38 | s | 49 | s |
| | Raft | 0.11 | s | 0.13 | s | 0.16 | s |
| | Event-link | 0.25 | s | 0.6 | s | 1.05 | s |
| 10 KB | PBFT | 0.93 | s | 1.16 | s | 1.39 | s |
| | PoET | 0.04 | s | 0.05 | s | 0.05 | s |
| | PoW | 342 | s | 394 | s | 457 | s |
| | Raft | 0.15 | s | 0.2 | s | 0.28 | s |
| | Event-link | 0.32 | s | 0.65 | s | 1.34 | s |

Looking at Table 2, the reference consensus mechanism PoW has the largest average latency in all experimental cases. Transaction processing speed of the PoW consensus mechanism is much slower than the consensus mechanism of the present invention (labeled as “event-link” in Table 2), especially with a 10 KB transaction data. In fact, the transaction latency of the PoW consensus mechanism is more than 342 s, which is 300 times more than the consensus mechanism of the present invention.

The consensus mechanism of the present invention has improved the drawbacks of the PoW consensus mechanism, which include: large energy consumption and requiring a mining node with a strong configuration. Furthermore, the PoW consensus mechanism needs to wait for extra confirmations block that cause the latency to be much higher.

Compared with the PBFT consensus mechanism, transaction latency of the consensus mechanism of the present invention is initially better, but then the difference between the two methods gradually reduces as the number of nodes increases. This can be explained by the objective of the PBFT algorithm, which seeks for quick and confirmation-less transactions. That helps transaction latency to stay more stable when the number of nodes increases.

The PBFT consensus mechanism requires trust, and an elected leader node makes it somewhat centralized. Compared with the other two algorithms (PoET and Raft), the transaction latency of the consensus mechanism of the present invention is both worse, but it can solve the downsides of these algorithms. Both the PoET consensus mechanism and the PBFT consensus mechanism require the user to put their trust in Intel, causing the system to be centralized and not trustless. The Raft consensus mechanism is too dependent on the leader node that is responsible for decisions. It can be susceptible to attacks and large volumes of transactions may result in system congestion.

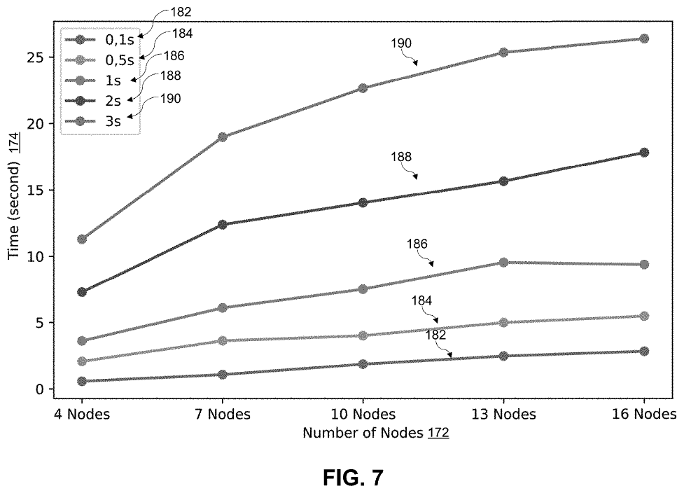

With the consensus mechanism of the present invention, the system needs to wait until an event is committed by endorsing peers, which results in a higher latency. However, in the consensus mechanism of the present invention, all participating nodes are equal and it does not require trust with any specific peer, making the system more decentralized. In addition, because the gossip interval also affects the time a transaction is committed, the gossip time was set to 1 second to keep the system stable. It should be noted that the transaction latency depends not only on the number of participating nodes, but also on the gossip interval. The result of transaction latency is described in FIG. 7.

### Example 4: Transaction Latency with Varying Gossip Intervals

Specifically, FIG. 7 has an x-axis 172 associated with the number of nodes and a y-axis 174 associated with a time in seconds. Gossip intervals of 0.1 seconds 182, 0.5 seconds 184, 1 seconds 186, 2 seconds 188, and 3 seconds 190 and transactions have an empty body data. As shown in FIG. 7, when the gossip time reduces, the transaction latency will be significantly lower. For instance, with the gossip interval of 0.1 seconds 182, the transaction latency is remarkably small in all five cases of node numbers. The reason is that every 0.1 seconds (e.g., the gossip interval), a node in the system synchronizes with other nodes so that the transaction can be confirmed quickly. In contrast, if the gossip time increases, the transaction latency can be undoubtedly higher, but the system will be able to run more stably and avoid overloaded participating nodes.

### Transaction Throughput

In terms of transaction throughput, a very large number of transactions are pushed to the nodes in the network. In particular, every 1024 transactions corresponds to one node, which means if a network has N nodes, Nx1024 transactions are pushed. In such a context, the TPS for each second is measured, from which a maximum TPS and a minimum TPS can be found. Finally, when all of the TPS values for each second are measured, an average sum is taken to calculate an average TPS.

### Example 5: Throughput of the Consensus Protocol of the Present Invention with a Transaction Size of 1 KB and a Gossip Interval of 1 Second

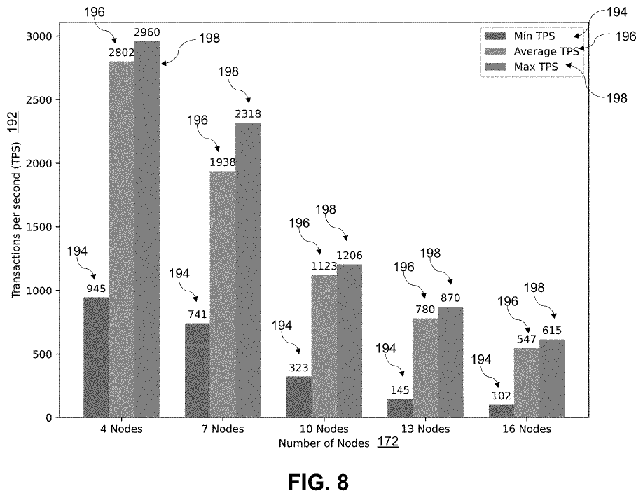

Specifically, FIG. 8 depicts transaction throughput of the consensus protocol of the present invention with a transaction size of 1 KB and a gossip interval of 1 second. Specifically, FIG. 8 includes an x-axis 172 associated with the number of nodes and a y-axis 192 associated with the TPS. The minimum TPS 194, the average TPS 196 and the maximum TPS 198 are depicted in FIG. 8. It can be seen that the minimum TPS 194, the average TPS 196 and the maximum TPS 198 tend to fall gradually when the number of nodes increases. It can also be noted that every average TPS 196 is only about 10% less than the maximum TPS 198, which indicates that in most cases the measured throughput is far from the minimum throughput. Because initially when starting to send transactions, the nodes begin to process and the amount of TPS is not high, as many transactions are in a “pending” state. As the system becomes more stable later on, the average TPS 196 is quite close to the maximum TPS 198.

### Example 6: Transaction Throughput for the Consensus Mechanism of the Present Invention as Compared to Reference Consensus Protocols

Table 3 below depicts the transaction throughput of the proposed consensus protocol and four reference consensus protocols.

TABLE 3

| Data | Consensus | Number of nodes | | | | | |
|---|---|---|---|---|---|---|---|
| size | protocol | 4 Nodes | | 7 Nodes | | 10 Nodes | |
| 1 KB | PBFT | 99.28 | TPS | 49.92 | TPS | 30.8 | TPS |
| | PoET | 43.6 | TPS | 39.3 | TPS | 29.8 | TPS |
| | PoW | 21.63 | TPS | 14.38 | TPS | 9.08 | TPS |
| | Raft | 535.5 | TPS | 407.6 | TPS | 374.3 | TPS |
| | Event-link | 2802.07 | TPS | 1937.85 | TPS | 1122.5 | TPS |
| 10 KB | PBFT | 50.52 | TPS | 28.68 | TPS | 18.9 | TPS |
| | PoET | 11.8 | TPS | 9.9 | TPS | 7.25 | TPS |
| | PoW | 1.45 | TPS | 1.05 | TPS | 0.74 | TPS |
| | Raft | 364.8 | TPS | 289.6 | TPS | 204.8 | TPS |
| | Event-link | 637.6 | TPS | 512.43 | TPS | 395.56 | TPS |

Specifically, Table 3 compares the TPS values of the proposed consensus mechanism (e.g., “event-link”) with four reference consensus mechanisms in the following scenarios: 1 KB or 10 KB transaction size in the context of 4, 7 or 10 nodes. For both different transaction sizes, the proposed consensus mechanism achieved a significantly higher TPS value than the other consensus mechanisms. It can be seen from Table 3 that the proposed consensus mechanism provides up to 2802.07 transactions per second (with 1 KB transactions and 4 nodes). In that case, the proposed consensus mechanism's TPS value is 28 times higher than the PBFT consensus mechanism, 64 times higher than the PoET consensus mechanism, 160 times higher than the PoW consensus mechanism, and 5 times higher than the Raft consensus mechanism. Transaction throughput gets smaller when the transaction size increases and/or when the number of nodes in the network increases.

At the time the proposed consensus mechanism reaches the smallest transaction throughput, which is 395.56 TPS (in the context of 10 KB transaction and 10 nodes), it still remain 20.9 times higher than the PBFT consensus mechanism, 54 times higher than the PoET consensus mechanism, 179 times higher than the PoW consensus mechanism, and 1.9 times higher than the Raft consensus mechanism. In the proposed consensus mechanism, nodes are based on their own event knowledge and the event reasoning mechanism, which is the reason why the events are quickly committed. This allows the system to process a larger volume of transactions as compared to other consensus mechanisms in the same amount of time.

Additionally, it is noticeable that the TPS of the Raft consensus mechanism is also fairly high, but it has a downside of being too dependent on leader node as explained. The consensus mechanism of the present invention is able to solve this problem while keeping throughput at a high measure.

### Example 7: Transaction Throughput when the Number of Nodes Increases from 4 to 16

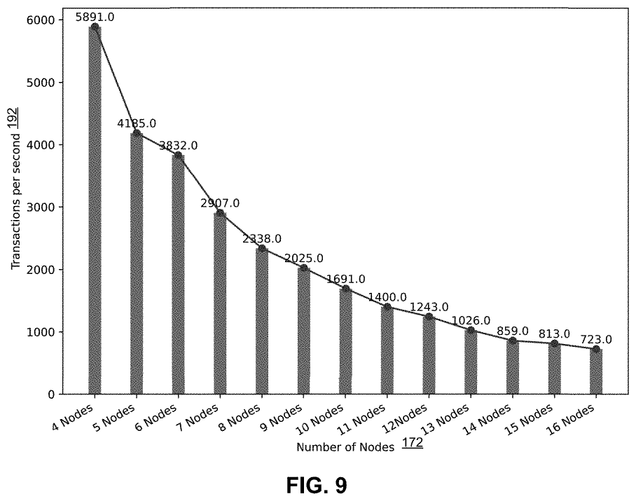

To evaluate how the number of nodes affects the TPS, the transaction throughput value is measured when the number of nodes increases from 4 to 16 as shown in FIG. 9. Specifically, FIG. 9 includes an x-axis 172 associated with a number of nodes and a y-axis 192 associated with the TPS. The transactions are continuously sent to nodes until the system is overloaded. In general, the graph tends to fall gradually when the number of nodes increases, but it is not a linear decrease line. At the beginning of the graph in FIG. 9, the TPS decreased significantly (about 1700 TPS) from 5891 TPS to 4185 TPS while there was a jump from 4 nodes to 5 nodes. However, when the number of nodes increases from 15 to 16, the TPS dropped slightly (about 90 TPS).

In the proposed consensus mechanism of the instant invention, all nodes have their own event knowledge so that they can commit and synchronize with other endorsing peers at the same time. As a result, system can process a high number of transactions during a time period. The gossip time is also an important factor affecting the TPS value. A low gossip interval allows nodes to send synchronous information and update the event knowledge faster. As a result, the TPS value increases due to the quick switch of transaction status from pending to committed.

### Average Event(Block) Closing Time

The average event/block closing time parameter is compared. This value of each event is calculated based on its previously adjacent event. A computation of all event closing times is completed, which is divided to the number of events to receive the average value. It is noted that the event delay for the proposed consensus mechanism of the instant invention is only measured with different numbers of nodes. For other consensus mechanisms known to those having ordinary skill in the art, there is no way to measure the time of new block generation in the blockchain network. The time spent to create a new block is set by the developer in their own system.

In detail, a Hyperleger Sawtooth platform is deployed for the PBFT and the PoET consensus mechanisms, so block closing time will be customized by the user. The user has the right to customize the block creation time for this mechanism. The Raft consensus mechanism deployed in Hyperledger Fabric is similar. With the PoW consensus mechanism, a new block is created depending on its difficulty. As such, if the difficulty is low, a block can be created at a faster speed.

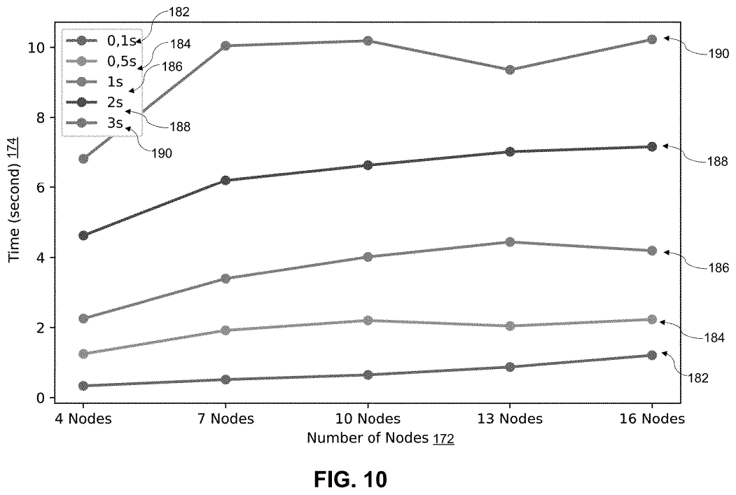

For the proposed consensus mechanism of the instant invention, the time for the event to be committed depends on the gossip interval. FIG. 10 shows the average event closing time through each specific case. Specifically, FIG. 10 has an x-axis 172 associated with the number of nodes and a y-axis 174 associated with a time in seconds. Gossip intervals of 0.1 seconds 182, 0.5 seconds 184, 1 seconds 186, 2 seconds 188, and 3 seconds 190 are depicted in FIG. 10. It can be seen in FIG. 10 that the gossip interval significantly affects event latency.

With this theory, the gossip interval is adjusted to accommodate different purposes. For instance, when the system is required to have a fast event committed speed, the gossip interval is reduced. Increasing the gossip interval can slow down the event committed time, but in return, this keeps the system safe and avoids overloading when there is an exceeding number of incoming transactions.

As such, the present invention describes a robust consensus protocol for use in blockchain-based IoT systems. IoT applications can act as sidechains operating independently of the mainchain. The sidechains share data via the mainchain. The proposed consensus protocol of the instant invention allows nodes to process a large number of transactions synchronously in the IoT system. Endorsing peers automatically commits events through the reasoning mechanism and event knowledge described herein. All of the nodes generally have equal power and increasing decentralization for the system. The synchronization mechanism described by the present invention can handle transaction throughput of up to 2802, 129 times higher than the PoW consensus mechanism, 64 times higher than the PoET consensus mechanism, 28 times higher than the PBFT consensus mechanism, and 5.2 times higher than the Raft consensus mechanism on the same hardware configuration. Although the transaction latency of the proposed consensus protocol of the instant invention is slightly higher than that of other reference consensus protocols, the proposed consensus protocol of the instant invention is still compatible with blockchain-based IoT systems.

Moreover as described, with traditional blockchain consensus mechanisms, each node must broadcast the transactions across the network, each node must share the transaction results across the network, and each node must share the voting results on the transaction results across the network. With each transaction, each node on the network must create three kinds of communications to broadcast information across the network.

Conversely, using the proposed consensus protocol and the reasoning mechanism of the instant invention, each node only needs to broadcast the current state (events and their transactions) of its knowledge graph to others. Further, the number of communications between the nodes is less than prior works because each node only needs to create one kind of communication and send it to only one other node. Besides, multiple events can be put into a communication to share with other nodes. As such, the goal of the reasoning mechanism is to determine the satisfying events on the knowledge graph (e.g., the events that are synchronized on at least ⅔ nodes on the network).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system configured to assist blockchain-based Internet of Things (IoT) applications connect with one another and share data securely and privately, the system comprising:
an IoT network comprising a plurality of IoT systems, wherein each IoT system of the plurality of IoT systems comprises a plurality of IoT devices that comprise sensors; and
a blockchain network comprising:
a mainchain; and
a plurality of sidechains,
wherein the IoT network is configured to collect data from the sensors of the plurality of IoT devices and transfer the data to the blockchain network, and
wherein the plurality of sidechains receive and store the data from the plurality of IoT systems.

2. The system of claim 1, wherein each sidechain of the plurality of sidechains are permissionless blockchains or permissioned blockchains.

3. The system of claim 1, wherein the mainchain functions as a permissionless blockchain so that the data is public.

4. The system of claim 1, wherein the plurality of sidechains are configured to share additional data with the mainchain via a two-way peg.

5. The system of claim 4, wherein the two-way peg consists of at least one node, and wherein the two-way peg synchronizes a block header from the plurality of sidechains to the mainchain.

6. The system of claim 5, wherein the mainchain utilizes smart contracts to identify a given sidechain in the plurality of sidechains, store the block header in the sidechain corresponding to a sidechain identification, and identify an organization that can submit a new block header to a data model.

7. The system of claim 1, wherein each of the plurality of sidechains comprises a consensus protocol.

8. The system of claim 7, wherein the consensus protocol runs on each node and is configured to increase data synchronization between nodes.

9. The system of claim 7, wherein the consensus protocol utilizes a reasoning mechanism to enable each node to deduce states of events on other nodes.

10. The system of claim 7, wherein the consensus protocol utilizes a gossip algorithm to synchronize data between nodes.

11. The system of claim 7, wherein the consensus protocol utilizes a vector clock algorithm in a knowledge graph deployed on every node.

12. The system of claim 11, wherein the knowledge graph comprises a timeline, an event, and a synchronization arrow.

13. The system of claim 12, wherein the event comprises transaction data, and wherein the event comprises a pending state and a committed state.

14. The system of claim 12, wherein the vector clock algorithm allows the event created during synchronization to be linked to the previous two events.

15. A method executed by a consensus protocol running on each node in a sidechain, the sidechain being located in a blockchain network, to determine satisfying events on that node's knowledge graph, the method comprising:
receiving, by a node in a sidechain, a synchronization message;
creating a new event on a timeline of a knowledge graphs;
marking the new event as a pending event;
utilizing a reasoning mechanism to select a newest event on each timeline of the knowledge graph;
utilizing a reasoning operator of the reasoning mechanism on each vector dimension; and
modifying a satisfying event from a pending state to a committed state such that the knowledge graph is updated into a new state, wherein the satisfying event is stored in at least two-thirds of a total number of nodes in a network.
